(19) United States
(12) Patent Application Publication
(10) Pub. No.: US 2023/0244347 A1
(43) Pub. Date: Aug. 3, 2023

(54) DISPLAY OPERATION SECTION AND DEVICE

(71) Applicant: Oki Electric Industry Co., Ltd., Tokyo (JP)

(72) Inventors: Masami NAGAOKA, Tokyo (JP); Yoshinori KOUMA, Tokyo (JP)

(73) Assignee: Oki Electric Industry Co., Ltd., Tokyo (JP)

(21) Appl. No.: 18/011,122

(22) PCT Filed: Apr. 22, 2021
(86) PCT No.: PCT/JP2021/016359

§ 371 Date: Dec. 16, 2022

(30) Foreign Application Priority Data
Jun. 26, 2020 (JP) 2020-110953

(51) Int. Cl. G06F 3/042; G06F 3/01; G07F 19/00

(52) U.S. Cl. CPC G06F 3/0428; G06F 3/016; G06F 3/0421; G07F 19/206; H04N 13/398

(57) ABSTRACT

There are provided a display operation section and a device that can suppress a risk from a viewpoint of hygiene. A display operation section includes: a display section including an operation screen; and an optical operation section arranged above the display section and configured to sense an operation on the operation screen, and the display section and the operation section are arranged apart from each other to form a non-sensing space between a sensing area configured to be able to sense the operation, and the operation screen. The display operation section further includes a plate-like or sheet-like protection member configured to protect the operation screen. The non-sensing space is formed between the sensing area and the protection member.

### TECHNICAL FIELD

The present invention relates to a display operation section and a device.

### BACKGROUND ART

Automatic transaction devices such as Automated Teller Machines (ATMs) and ticket vending machines are installed at financial institutions or distribution institutions. A device such as an automatic transaction device includes an operation screen, and the operation screen is realized by, for example, a display with a touch panel.

Regarding the operation screen, for example, a technology of Patent Literature 1 is proposed. According to Patent Literature 1, infrared light radiated from a touch panel is detected to sense a touch on the touch panel.

### CITATION LIST

### Patent Literature

Patent Literature 1: JP 2003-223280A

### SUMMARY OF INVENTION

### Technical Problem

However, according to a structure of a conventional operation screen, an unspecified number of operators touch a touch panel, and therefore the touch panel becomes a factor to mediate viruses, and causes a risk from a viewpoint of hygiene.

Accordingly, the present invention is made in view of the aforementioned issue, and provides a display operation section and a device that can suppress a risk from a viewpoint of hygiene.

### Solution to Problem

In order to solve the above issue, a display operation section according to one aspect of the present invention includes: a display section including an operation screen; and an optical operation section arranged above the display section and configured to sense an operation on the operation screen, and the display section and the operation section are arranged apart from each other to form a non-sensing space between a sensing area configured to be able to sense the operation, and the operation screen.

Furthermore, a device according to one aspect of the present invention is a device that includes the above display operation section.

### Advantageous Effects of Invention

According to the present invention, it is possible to suppress a risk from a viewpoint of hygiene.

### BRIEF DESCRIPTION OF DRAWINGS

FIG. 1 is an external view of an automated teller machine according to a first embodiment of the present invention.

FIG. 2 is a view for explaining a display operation section according to the first embodiment of the present invention, and is an enlarged cross-sectional view

FIG. 3 is a view for explaining a configuration of the operation section, and illustrates a case as a virtual line.

FIG. 4 is a cross-sectional view of a display operation section according to a second embodiment of the present invention.

FIG. 5 is a cross-sectional view of a display operation section that does not include a non-sensing space according to a comparative example.

### DESCRIPTION OF EMBODIMENTS

Embodiments of the present invention will be described in detail below with reference to the drawings. Each drawing only schematically illustrates the present invention to such a degree that the present invention is understandable. Accordingly, the present invention is not limited only to illustrated examples. Furthermore, there is a case where dimensions of members that make up the present invention are exaggerated and expressed to clarify explanation in the drawings to be referred to. Note that common components and similar components in each drawing will be assigned the same reference numerals, and overlapping description thereof will be omitted.

### First Embodiment

### Configuration of Automated Teller Machine (ATM) According to First Embodiment

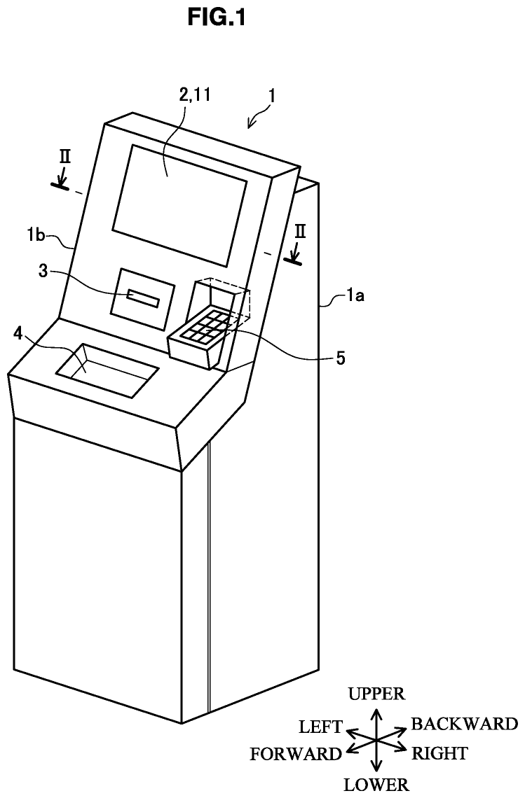

A configuration of an automated teller machine 1 according to the first embodiment will be described with reference to FIG. 1. The automated teller machine 1 is a device that provides financial service to clients, and performs transaction related to cash such as deposit transaction and withdrawal transaction to and from users. The automated teller machine 1 is installed at, for example, bank branches and convenience stores. Note that the automated teller machine 1 is an example of a “device” in the claims.

“Upper and lower”, “forward and backward”, and “left and right” in description of the automated teller machine 1 correspond to arrows in FIG. 1. The directions are defined for the sake of convenience of description, and do not limit the present invention. Note that a forward direction in FIG. 1 is a direction in which a user (i.e., a client of a financial institution) of the automated teller machine 1 is positioned.

As illustrated in FIG. 1, the automated teller machine 1 is attached a display panel 1b on a front surface of a device main body 1a, and includes a display operation section 2, a card statement slot 3 through which a cash card is inserted and ejected, and transaction details are ejected, a bill slot 4 through which bills are inserted and ejected at a time of deposit and withdrawal, and a number input section 5 at which personal identification numbers are input at a time of transaction. When, for example, performing withdrawal transaction, an operator pushes buttons of the display operation section 2, inserts a cash card in the card statement slot 3 according to a displayed guidance, and inputs personal identification numbers at the number input section 5. By this means, the operator can withdraw cash. Note that the configuration of the automated teller machine 1 illustrated in FIG. 1 is only exemplary, and may be another configuration such as a configuration where, for example, the number input section 5 is omitted.

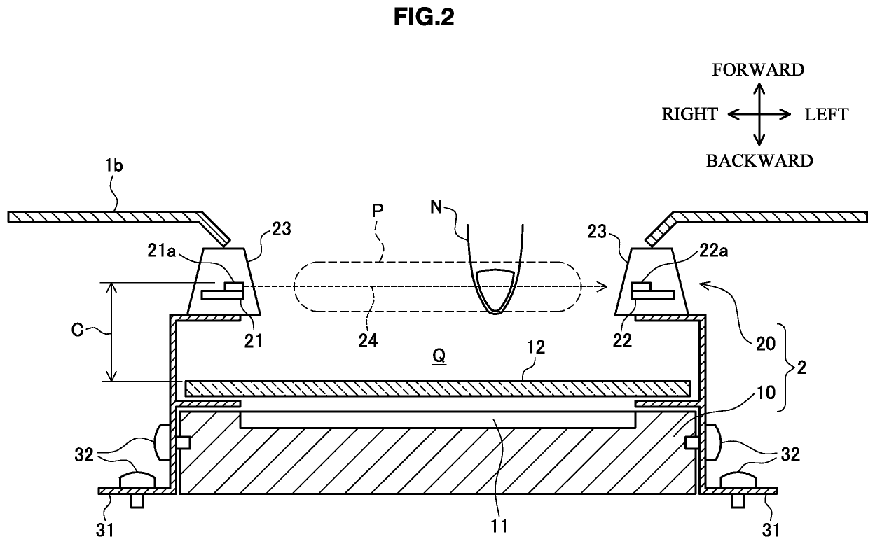

The display operation section 2 will be described with reference to FIG. 2. FIG. 2 is an enlarged cross-sectional view corresponding to II-II in FIG. 1. The display operation section 2 is a non-contact type touch panel. That is, a user finishes input by touching air without touching the display operation section 2.

The display operation section 2 mainly includes a display section 10 and an operation section 20. The display operation section 2 may further include components (e.g., members that protect or support the display section 10 and the operation section 20) that accompany the display section 10 and the operation section 20.

The display section 10 is, for example, a Liquid Crystal Display (LCD). The display section 10 includes an operation screen 11, and the operation screen 11 displays various pieces of information (e.g., buttons) related to an operation. The operation screen 11 according to the present embodiment has a rectangular shape. The display section 10 is fixed to the device main body 1a (see FIG. 1) by fixing screws 32 with attachment metal fittings 31 interposed therebetween. A protection member 12 for protecting the operation screen 11 is provided on a top surface side (operation screen 11 side) of the display section 10. The protection member 12 is assumed as a plate member made of glass, yet may be a sheet-like member. The protection member 12 is pasted and fixed to the attachment metal fittings 31 by, for example, a double-sided tape. The protection member 12 in a fixed state is parallel to the operation screen 11, and is apart from the operation screen 11. Note that fixing means of the protection member 12 is not limited to the double-sided tape, and various methods can be selected. Furthermore, a position of the protection member 12 is not limited to an illustrated position, either.

The operation section 20 is an optical sensor device that senses an operation on the operation screen 11. The operation section 20 is arranged in front of (i.e., above in FIG. 2) the protection member 12 (i.e., operation screen 11). The operation section 20 includes infrared light emission sections 21 and infrared light reception sections 22. The infrared light emission sections 21 and the infrared light reception sections 22 are arranged facing each other with the operation screen 11 interposed therebetween, and infrared light 24 radiated by light emission elements 21a included in the infrared light emission sections 21 is received by light reception elements 22a included in the infrared light reception sections 22. The light emission elements 21a and the light reception elements 22a are aligned and arranged on a substrate. An area that is a space to be irradiated with the infrared light 24 and can sense an operation on the operation screen 11 is referred to as a “sensing area P” below.

The infrared light emission sections 21 and the infrared light reception sections 22 are housed in a case 23 of a rectangular frame shape. The case 23 is pasted and fixed to the attachment metal fittings 31 by, for example, a double-sided tape. Most of the operation section 20 is covered with the display panel 1b such that the operator cannot visually check the operation section 20.

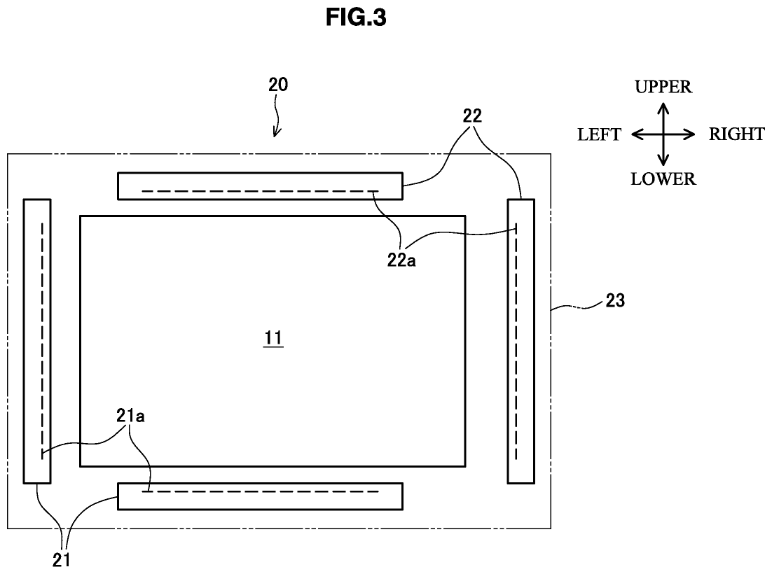

FIG. 3 illustrates an arrangement in a case where the infrared light emission sections 21 and the infrared light reception sections 22 are seen from the front side. Note that FIG. 3 illustrates the case 23 as virtual lines. As illustrated in FIG. 3, the infrared light emission sections 21 and the infrared light reception sections 22 have elongated shapes. The infrared light emission sections 21 are located on outer sides of a left edge part (left side part) and a lower edge part (lower side part) of the operation screen 11, and the light emission elements 21a are linearly arranged along the left edge part (left side part) and the lower edge part (lower side part). Furthermore, the infrared light reception sections 22 are located on outer sides of a right edge part (right side part) and an upper edge part (upper side part) of the operation screen 11, and the light reception elements 22a are linearly arranged along the right edge part (right side part) and the upper edge part (upper side part). Note that the left edge part is an example of a “first edge part” in the claims, the right edge part is an example of a “second edge part” in the claims, the lower edge part is an example of a “third edge part” in the claims, and the upper edge part is an example of a “fourth edge part” in the claims.

The display section 10 and the operation section 20 according to the present embodiment are arranged apart from each other to form a space between the sensing area P and the display section 10. This space is an area in which the infrared light 24 of the operation section 20 does not pass and presence of an object (a finger N of the user in this case) is not sensed, and therefore is referred to as a “non-sensing space Q”. A distance C (i.e., a width dimension of the non-sensing space Q) between the protection member 12, and the infrared light emission sections 21 and the infrared light reception sections 22 is such a distance that the finger N does not touch the protection member 12 when the operator inserts in the sensing area P the finger N for operating the display operation section 2, and is preferably, for example, “approximately 20 mm to 100 mm”.

### Operation of Automated Teller Machine (ATM) According to First Embodiment

When the automated teller machine 1 is operated, the infrared light 24 emitted from the infrared light emission sections 21 is blocked by, for example, inserting the finger N toward a transaction button displayed on the operation screen 11. Thus, the operation section 20 senses a push place, and notifies an unillustrated control section of the push place. The control section executes control (e.g., cash withdraw process) based on the push place.

Note that there are various methods that associate blocking of the infrared light 24 emitted from the infrared light emission sections 21 and display of the operation screen 11. When, for example, the infrared light 24 is blocked, it is displayed that a button has been selected, and, when the infrared light 24 is deblocked, the display of the button is returned to an original state. Furthermore, when the infrared light 24 is blocked, it may be displayed that a button has been selected, and, even when the infrared light 24 continues being blocked, the display of the button may be returned to the original state after a certain period of time passes.

As described above, the display operation section 2 according to the first embodiment includes a certain distance between the protection member 12 (i.e., operation screen 11), and the infrared light emission sections 21 and the infrared light reception sections 22. Consequently, the operator can perform an operation without touching the protection member 12, and hedge a risk from a viewpoint of hygiene.

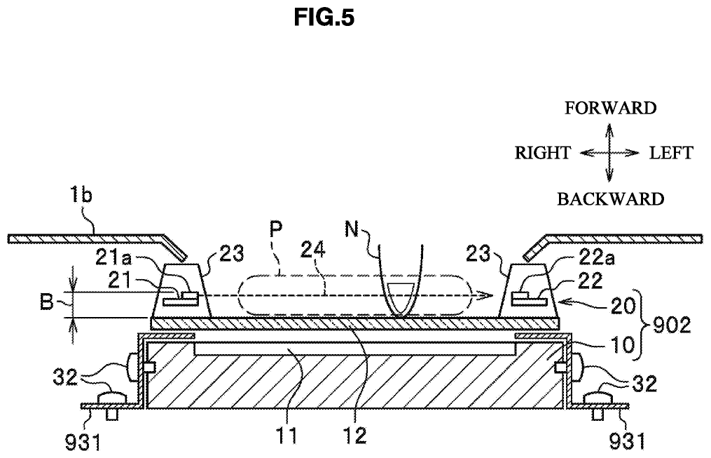

FIG. 5 illustrates a display operation section 902 for which the non-sensing space Q (see FIG. 2) is not formed as a comparative example for explaining an effect of the present invention. The display operation section 902 illustrated in FIG. 5 includes the display section 10 and the operation section 20. Configurations of the display section 10 and the operation section 20 are the same as those of the first embodiment. The display operation section 902 is formed by directly pasting and fixing the operation section 20 to the protection member 12 by using a double-sided tape. Note that the protection member 12 is assumed as a plate member made of glass similar to the first embodiment, and are pasted and fixed to attachment metal fittings 931 by a double-sided tape. Hence, a distance B between the protection member 12, and the infrared light emission sections 21 and the infrared light reception sections 22 is not sufficient, and the sensing area P is formed near the protection member 12. As a result, when operating a device, an operator touches the protection member 12 with the finger N by moving the finger N toward a transaction button displayed on the display section 10, and therefore there is a risk from a viewpoint of hygiene.

### Second Embodiment

According to the first embodiment, a structure is provided with a certain gap between the display section 10 and the operation section 20 to form the non-sensing space Q between the sensing area P and the display section 10. According to second embodiment, convenience is further improved by using this non-sensing space Q.

### Configuration of Automated Teller Machine (ATM) According to Second Embodiment

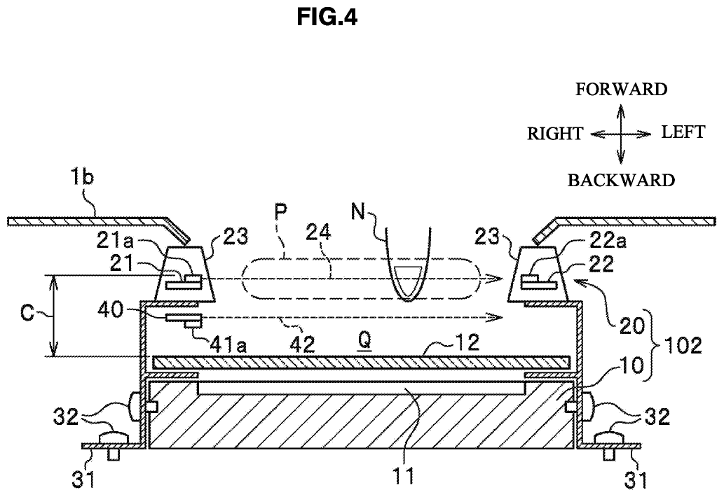

A configuration of a display operation section 102 according to the second embodiment will be described with reference to FIG. 4. FIG. 4 is a cross-sectional view of the display operation section 102 according to the second embodiment.

The display operation section 102 includes the display section 10, the operation section 20, and a light emission section 40. That is, a difference from the first embodiment is that the display operation section 102 includes the light emission section 40. Configurations of the display section 10 and the operation section 20 are the same as those of the first embodiment, and therefore detailed description thereof will be omitted hereinafter. Note that the light emission section 40 is an example of a “notification section” in the claims.

The light emission section 40 is, for example, a Light Emitting Diode (LED), and is arranged between the infrared light emission sections 21 and the display section 10. The light emission section 40 includes light emission elements 41a that radiate visible light 42, and the light emission elements 41a operate in conjunction with sensing of an operation of the operation section 20, and give a visual change to an operator. The light emission elements 41a are linearly arranged similar to, for example, the light emission elements 21a of the operation section 20, and the light emission elements 41a meeting portions at which the infrared light 24 is blocked (i.e., a place at which the finger N is sensed) flash in conjunction. Furthermore, all or part of the corresponding light emission elements 41a may start or finish irradiating the non-sensing space Q with the visible light 42 in conjunction with sensing of the operation of the operation section 20.

### Operation of Automated Teller Machine (ATM) According to Second Embodiment

When the automated teller machine 1 is operated, the infrared light 24 emitted from the infrared light emission sections 21 is blocked by, for example, inserting the finger N toward a transaction button displayed on the operation screen 11. Thus, the operation section 20 senses a push place, and notifies the unillustrated control section of the push place. The control section notifies the light emission section 40 of the push place, and the light emission section 40 causes the light emission element 41a meeting, for example, the push place to flash. Furthermore, the control section executes control (e.g., cash withdraw process) based on the push place.

The display operation section 102 according to the above-described second embodiment can also provide the substantially same effect as that of the first embodiment.

Furthermore, according to the display operation section 102 according to the second embodiment, the light emission section 40 gives a visual change to the operator in conjunction with sensing of the operation of the operation section 20. Consequently, the operator can easily grasp the depth for inserting the finger N, so that it is possible to improve operability and further avoid contact with the protection member 12 due to excessive insertion.

### Third Embodiment

According to the third embodiment, convenience is further improved by changing display of the operation screen 11. Note that a configuration of a display section (not illustrated) according to the third embodiment is the same as that of the display operation section 2 according to the first embodiment or the display operation section 102 according to the second embodiment. Hence, description using the drawings will be omitted.

### Operation of Automated Teller Machine (ATM) According to Third Embodiment

When the automated teller machine 1 is operated, the infrared light 24 emitted from the infrared light emission sections 21 is blocked by, for example, inserting the finger N toward a transaction button displayed on the operation screen 11. Thus, the operation section 20 senses a push place, and notifies the unillustrated control section of the push place. The control section changes a sensed display portion (a number, a button, or all or part of combinations thereof) (vibration, enlargement/reduction of sizes, and change of characters and symbols, brightening/darkening of brightness, or combination thereof). Furthermore, the control section may, for example, enlarge buttons and/or characters, or widen arrangement intervals. Furthermore, the control section may keep, for example, existing sizes of buttons and/or characters, or existing arrangement intervals.

According to the display operation section (not illustrated) according to the above-described third embodiment, it is possible to provide the substantially same effect as that of the first embodiment.

Furthermore, the display operation section according to the third embodiment changes display of a sensed portion in conjunction with sensing of an operation of the operation section 20. Consequently, the display becomes visually intelligible, and operability improves. Furthermore, a reaction of an operation is intelligible, so that it is possible to further avoid contact with the protection member 12 due to excessive insertion. Furthermore, by enlarging sizes of the buttons displayed on the operation screen 11, or widening intervals of the buttons, it is possible to prevent erroneous input.

### Modified Example

Although the embodiments of the present invention have been described above, the present invention is not limited to these, and can be carried out without departing from the spirit of the claims. The modified example of the embodiments is, for example as follows.

Each embodiment has assumed the automated teller machine as a device that includes the display operation section. However, the device provided with the display operation section according to each embodiment is not limited to the automated teller machine, and is applicable to various devices (e.g., ticket vending machines). That is, types of devices that are targets to be provided with the display operation section are not limited.

Furthermore, according to the second embodiment, completion of an operation has been notified to the operator by using the visible light 42 radiated from the light emission section 40. That is, the light emission section 40 is an example of the “notification section” in the claims, and has exemplified the example of the notification section. However, means for notifying the operator of completion of an operation is not limited to this, and it is possible to notify the operator of completion of an operation by causing various physical phenomena in the non-sensing space Q. There may be employed, for example, a configuration that includes a convection section (e.g., air blower) that convects air in the non-sensing space Q or an ultrasonic wave section that emits ultrasonic waves to the non-sensing space Q instead of the light emission section 40.

Furthermore, each embodiment has assumed that the operation screen 11 of the display section 10 displays various pieces of information (e.g., buttons) related to operations. However, a stereoscopic image (that may be a stereoscopic video image) can be also used. In this case, there is employed, for example, a configuration that includes an image formation section that forms a stereoscopic image including information (e.g., buttons) related to operations instead of the display section 10. Furthermore, the image formation section is arranged such that the non-sensing space Q is formed between the sensing area P and the stereoscopic image. By so doing, it is possible to completely prevent contact with the display section 10.

Furthermore, although the light emission elements 21a and the light reception elements 22a are arranged at the four sides of the operation screen 11 in each embodiment, the light emission elements 21a and the light reception elements 22a may not be arranged at all sides. For example, pairs of the light emission elements 21a and the light reception elements 22a may be arranged only at the two sides. In a case where the pairs of the light emission elements 21a and the light reception elements 22a are arranged at the two sides, for example, one of two or three or more buttons displayed in a row in an upper/lower direction, a left/right direction, or an oblique direction of the operation screen 11 is selected, so that it is possible to reduce cost compared to the case of the four sides. Furthermore, in a case where the pairs of the light emission elements 21a and the light reception elements 22a are arranged at the two sides, for example, one button displayed on the operation screen 11 is selected, so that it is possible to reduce cost compared to the case of the four sides.

Furthermore, each embodiment has assumed a case where the display section 10 and the operation section 20 are integrated (i.e., a case where the display section 10 and the operation section 20 makes up one unit). However, for example, the operation section 20 can also make up one unit, and be attached later to the device such as the automated teller machine 1. In this case, the operation section 20 according to the embodiments can be attached in place of an existing operation section conventionally provided to the device such as the automated teller machine 1. Furthermore, the operation section 20 according to the embodiments may be overlaid and attached above the existing operation section. In this case, for example, activation of the existing operation section may be stopped to use a sensing area of the existing operation section as the non-sensing space Q according to the present embodiment.

Furthermore, part of the respective components described in each embodiment may be combined/omitted. Furthermore, all or part of the components and/or the functions in each of the embodiments and each modified example described above may be combined. Furthermore, at least part of the components and/or the functions in each of the embodiments and each modified example may be omitted. Alternatively, at least part of the components and/or the functions in each of the embodiments and each modified example may be replaced with the components and/or the functions in the other embodiments and other examples. Alternatively, at least part of the components and/or the functions in each of the embodiments and each modified example may be added as new components and/or functions to at least one of the other embodiments and other examples.

### REFERENCE SIGNS LIST

1 automated teller machine (device)
2, 102 display operation section
10 display section
11 operation screen
12 protection member
20 operation section
21 infrared light emission section
21a light emission element
22 infrared light reception section
22a light reception element
23 case
24 infrared light
31 attachment metal fitting
32 fixing screw
40 light emission section
41 light emission element
42 visible light
P sensing area
Q non-sensing space

1. A display operation section comprising:
a display section including an operation screen; and
an optical operation section arranged above the display section and configured to sense an operation on the operation screen,
wherein the display section and the operation section are arranged apart from each other to form a non-sensing space between a sensing area configured to be able to sense the operation, and the operation screen.

2. The display operation section according to claim 1, further comprising a plate-like or sheet-like protection member configured to protect the operation screen,
wherein the non-sensing space is formed between the sensing area and the protection member.

3. The display operation section according to claim 1, wherein
the operation screen has a rectangular shape, and
the operation section includes
a first infrared light emission element linearly arranged along a first edge part that makes up the operation screen,
a first infrared light reception element linearly arranged along a second edge part facing the first edge part, and configured to receive infrared light radiated from the first infrared light emission element,
a second infrared light emission element linearly arranged along a third edge part that makes up the operation screen, and
a second infrared light reception element linearly arranged along a fourth edge part facing the third edge part, and configured to receive infrared light radiated from the second infrared light emission element.

4. The display operation section according to claim 1, further comprising a notification section arranged between the display section and the operation section, and configured to give a notification of completion of the operation by causing a physical phenomenon in the non-sensing space.

5. The display operation section according to claim 4,
wherein the notification section is one of a light emission section configured to start or end radiation of visible light to the non-sensing space in conjunction with the sensing of the operation of the operation section, a convection section configured to convect air in the non-sensing space, and an ultrasonic wave section configured to emit an ultrasonic wave to the non-sensing space.

6. The display operation section according to claim 1,
wherein the display section changes display of a sensed portion in conjunction with the sensing of the operation of the operation section.

7. A display operation section comprising:
an image formation section configured to form a stereoscopic image including information related to an operation; and
an optical operation section configured to sense an operation on the stereoscopic image,
wherein a non-sensing space is formed between a sensing area configured to be able to sense the operation, and the stereoscopic image.

8. A device comprising the display operation section according to claim 1.

9. The display operation section according to claim 1, wherein
the display operation section is attached to a device main body, and
the display section is attachable to the device main body by a fixing part.

10. The display operation section according to claim 9,
wherein the display section is detachable from the device main body by the fixing part.

11. A device comprising the display operation section according to claim 9,
wherein the device further comprises a touch operation section configured to sense a touch on the display section, and accept an operation.

12. The device according to claim 11, further comprising a switch section configured to stop activation of the touch operation section, and enable the operation section to sense the operation on the display section.

13. A device comprising the display operation section according to claim 1,
wherein the device further comprises a touch operation section configured to sense a touch on the display section, and accept an operation.
